(19) United States
(12) Patent Application Publication
(10) Pub. No.: US 2020/0309644 A1
(43) Pub. Date: Oct. 1, 2020

(54) UNIVERSAL SAMPLING AND TRANSFER DEVICE

(71) Applicant: Field Forensics, Inc., St. Petersburg, FL (US)

(72) Inventors: Craig Johnson, St. Petersburg, FL (US); Sean Meehan, St. Petersburg, FL (US)

(73) Assignee: Field Forensics, Inc., St. Petersburg, FL (US)

(21) Appl. No.: 15/999,092

(22) PCT Filed: May 9, 2016
(86) PCT No.: PCT/US2016/031514

§ 371 Date: Aug. 17, 2018

Related U.S. Application Data
(60) Provisional application No. 62/296,510, filed on Feb. 17, 2016.

(51) Int. Cl. G01N 1/02; B01L 3/00; G01N 21/78

(52) U.S. Cl. CPC G01N 1/02; B01L 3/50; B01L 2300/0861; G01N 2001/028; B01L 2200/16; G01N 21/78

(57) ABSTRACT

A sampling and transfer device for chemicals, biologics and the like comprises a barrel containing at least one fluid reservoir fluidically coupled to a porous nib, such as a high density or ultra high density polyethylene porous nib. For example, the barrel may comprise a plurality of fluids such as buffers, solvents and/or reagents for a plurality of different types of tests such as spectroscopy, thin layer chromatography, DNA testing and testing for chemical reactivity with a reagent (i.e. colorimetric testing) that alters the appearance of the tip, such as by a change in color, luminosity or the like. In one method, a series of tests are conducted using the same nib for sampling and spotting a variety of surfaces for different types of tests having different sensitivities for different compounds and/or colorimetric testing of the tip, itself.

### CROSS RELATED APPLICATIONS

This application is a 371 U.S. national phase application of PCT/US2016/031514 filed May 9, 2016 which claims priority to U.S. provisional application 62/296,510 filed Feb. 17, 2016, which is incorporated by reference herein in its entirety.

### FIELD OF THE INVENTION

The field relates to devices used for swabbing surfaces for collecting trace residue or samples from liquid, solid or vapor.

### BACKGROUND

Thin layer chromatography is known. A parameter often used for qualitative evaluation is the Rf value (retention factor) or the 100 fold value hRf. The Rf value is defined as follows: Rf=(distance starting line−middle of spot)/(distance starting line−solvent front), and the Rf values are between 0 and 1 (best between 0.1 and 0.8 or 10-80 for hRf). If reproducible Rf values are to be obtained it is essential that several parameters such as chamber saturation, constant composition of solvent mixtures, constant temperature and other variables, such as spot location, are strictly controlled. A quantitative evaluation is possible by suitable calibration measurements and reference standards. For this purpose either the area of a substance spot is measured or a photometric evaluation is performed directly on the layer. A micropipette is used for spotting a liquid sample solution.

Various types of spectroscopy are known, which determine the presence or absence of a substance using detectors including some handheld or portable detectors. Typically, flat swabs or cotton swabs are used for sampling a surface, powder or liquid, and then a sample of the solvent containing diluted solute is transferred by a pipette or the like. For example, a cotton swab may be used for swabbing a surface for TLC. Then, the cotton swab is transferred to a solvent, and the solvent releases some or all of the substances swabbed from the cotton swab into the solvent. An amount of the solvent is extracted using a pipette and is spotted onto a specific location on a TLC plate or slide. This plate or slide is then inserted into a chamber with a mobile phase for a period of time to cause separation of substances carried a distance up the TLC plate or slide. In surface enhanced Raman spectroscopy (SERS), a cotton swab is used to sample a surface, is placed in a solvent, and then a SERS disk is coated, dipped or swabbed with the solvent containing diluted solute. A SERS disk is dried and then analyzed with a Raman spectroscope.

Colorimetric test kits are known that are quick and easy to use by swabbing a surface and chemically reacting whatever is swabbed with a reactant that causes a color change on the surface of the swab.

Nibs are known for writing instruments and the like. For example, US Pat. Publ. 2007/0225390 discloses a method for sintering polyethylene suitable for making porous nibs.

However, each of the different types of tests use substantially different procedures and different swabs and devices for collecting and transferring a sample to be tested, and there is no swab or device that may be used universally for a wide variety of different tests and procedures that can, itself, be use, also, in multiple analytical techniques. To the contrary, even the idea of a universal swab is unthinkable, because each swab is identified for a particular type of test. Only in a few types of simple, colorimetric tests can the swab even be used without transferring the sample from the swab, by inserting the swab into a solvent, prior to extracting some of the solvent and transferring the solvent to a slide, plate, disk or crucible for further processing or testing, such as with a pipette or the like. Usually, the swab is not used to transfer the sample without intervening steps in the process.

### SUMMARY

A sample collection and spotting device has a variety of uses, depending on how it is configured. In one example, a porous tip extends from a tubular member, such that fluid is capable of passing through the tubular member and into the tip. The porosity of the tip allows for the fluid, whether vapor or liquid, to pass through open pores from a distal end of the tip, coupled with the tubular member, to a proximal end of the tip, extending from the tubular member. In one example, the tip is a nib made of a sintered material. The sintering joins particles of the material, one to the other, but leaves open channels around the particles for fluid to flow into and through the nib, for example. The material may be a plastic or polymer material, such as polyethylene, for example.

For example, the device may be used as a spotter in thin layer chromatography. A chamber containing a fluid may be coupled to the tubular member coupled to the tip, for example, and the fluid, such as a diluent and/or solvent, may be directed to the tip through the porous network formed by partially sintering powdered materials. For example, the device may be a nib having a parabolic proximal end and a distal end shaped to be held in the tubular member fluidically coupling the chamber containing the fluid to the nib. In one example, the fluid is contained in one or more vials, such as glass vials that can be crushed to release the fluid, when needed. A second vial may contain a second fluid, which can be used for colorimetric testing, causing a chemical color change of the tip, indicating presence or absence of a chemical element or compound, for example.

The proximal end of the tip may be sized to “spot” the correct size of spot on a thin layer chromatography plate, for example. A spotting window on a thin layer chromatography kit may be provided for introducing the tip into a housing, such that the spot is positioned precisely where the spot is needed on the slide, for example. In this way, human error is reduced and thin layer chromatography may be completed in the field, for example.

In one example, the device comprises a tip for spotting a thin layer chromatography plate through a window in a housing and a colorimetric test kit. For example, the chamber comprises a first fluid releasable from a first vial, which is a suitable solvent for spotting whatever chemicals come into contact with the proximal end of the tip on a thin layer chromatography slide, and a second fluid releasable form a second vial, which is chemically reactive with one or more chemicals, such that a color change occurs at the tip.

Thus, the device may be used as a sample collection and spotting device for a plurality of tests, such as thin layer chromatography, colorimetric testing and spectroscopy. For example, spectroscopy testing of a nib may include ion mobility spectrometry (IMS), gas chromatography mass spectrometry (GC-MS) or differential mobility spectrometry (DMS).

In one example, a sintered nib and/or the entire device is pickable by an automated pipetter that uses the nib for transferring a sample solution from one place to one or more other places, automatically.

In one example, thin layer chromatography (TLC) is contemplated. The device is a spotter for a TLC plate or slide. For example, a first vial may contain a liquid solvent, such as methanol. In addition to methanol, the vial may contain a second compound, which may be used as a reference compound. In this way, the device may be used to spot a reference standard. Then, the tip may be used to interrogate a surface (such as by swabbing the surface or contacting the tip with a solid or liquid to be tested, such as a powder residue. Then, the device is used to spot the sample tested on the same or different TLC slide. In one example, a single slide has a plurality of tracks, separated one from another, but adjacent one to the other, such that the reference standard and the test track may be readily compared. In one example, the relative location of the TLC result is used to interpret the results in the field. In an alternative or the same example, a quantitative result may be determined by calibrating the results using the reference standard and determining a quantitative or semi-quantitative result from the results of TLC from the test spot. For example, the device may replace a micropipette for TLC spotting.

In one example, the nib has a shape other than a simple dot, such as a linear or rectangular shape. The more linear shape may provide an instant check to determine presence of a reactant on the tip, by darkening or a color change, for example. If only a portion of the linear tip is changed, then the tip may be moved to put the entire tip into contact with the substance to be tested, for example. The linear tip may be used for spotting, such as in TLC, and the precision of the TLC may be increased by better defining the distance from the linear “spot” and the end result on the TLC slide.

In one example, a plurality of nibs are provided in a single device. For example, a first nib may be fluidically coupled to a first mobile phase and the second nib may be fluidically coupled to a second mobile phase. A difference in the result obtained may be used to indicate or conform the type of substance tested or may increase reliability of the test. Alternatively, one nib may be made of a different material than another nib. For example, one may be a high comparatively highly conductive sintered metal and the other may be a polymer, such as sintered polyethylene.

A device may comprise a plurality of nibs, of the same type or different types, and a plurality of vials, containing a plurality of different solvents and/or reactants that may be used for rapid substance screening and detection in the field, for example.

In one example, a single device is used for both Raman spectroscopy and Fourier transform infrared spectroscopy (FTIR) by making the nib removable from the tubular member to which it is coupled during sample collection. For example, the nib may be held by a collar that is detachable from the tubular member. In one example, the nib is removable and may be replaced onto another tubular member, which contains a different solvent, such as chloroform, which allows the same nib to be used for FTIR, after having been used for Raman spectroscopy, previously. For example, a sintered metal nib may be used in a surface enhanced Raman spectroscopy (SERS) using a sintered metal such as Au, Ag, Cu, Li, Na, K, Pd or Pt metal or alloy, for example. Alternatively, a ceramic nib with a sample tip, such as a conical tip, rounded conical tip or parabolic tip, may be used to concentrate a sample for SERS on a portion of the tip used to transfer a sample to a SERS substrate or disk by introducing an amount of solvent such as methanol into a crushable ampoule or reservoir. The methanol is directed to the tip through the porosity of a porous nib, for example, and then the tip of the nib. The nib may be used to sample a liquid, powder or surface. Then, by directing additional methanol to the nib and holding the nib downward, any sample on the side of the nib tends to drain toward the tip of the nib, concentrating the sample at the tip of the nib. The radius of curvature of the nib may be sized to provide a spot of the sample having a diameter useful for transferring the concentrated sample onto a SERS substrate or disk, which is then inserted into a spectrometer, or interrogated directly by a handheld Raman spectrometer, for detection of compounds of interest.

In one method, the device is used by contacting the tip onto a surface or a substance to be tested. An ampoule or vial in the device is crushed, or otherwise activated, to release a solvent and/or mobile phase either before or after sampling the surface of substance, as appropriate. The tip is then used to spot a TLC plate or slide, without any solvent chamber being used to extract anything from the tip and without the use of a pipette to transfer the solvent to the plate or slide.

Thus, using the device is much easier and the cost and difficulty of training technicians to use the device in the field is simplified. People comparatively untrained in the laboratory techniques used to sample and analyze substances, such as detectives, soldiers and first responders, can reliably gather and analyze samples using the device, for example. Furthermore, by using the same device for sample collection and transfer in a plurality of different tests, such as TLC, spectroscopy, colorimetric and nuclear magnetic resonance (NMR), training and inventory costs are greatly reduced compared to the state of the art, which uses a variety of processes, swabs and collection devices.

For example, a nib may be made of a porous polyethylene, such as Porex's high density or ultra high density porous polyethylene, which is available in various form factors. A nib may have a base wider than its tip, such as a parabolic shape or a conical shape with a pointed or rounded truncated shaped tip. The radius of curvature or the contact radius of curvature may be selected for a variety of sampling and transfer applications, making the device a universal sampling and spotting device. Further enhancing the uses for a device, a barrel fluidically coupled to the tip may comprise a plurality of solvents and/or reagents and/or buffers. By integrating reservoirs for a variety of fluids within the barrel, the device becomes easy to stock and versatile, performing a plurality of roles as required by circumstances.

In one example, a universal sampling and transfer device comprises a barrel comprised of an external housing and at least one reservoir and a nib. The nib is fluidically coupled to the barrel and the at least one reservoir. The nib has a tip with a tip curvature greater than the curvature of the nib distal from the tip. The nib may be made of a sintered polyethylene, for example. The porosity of the nib may be selected in a range from 60 to 75 percent in one example. The at least one reservoir may comprise a plurality of reservoirs. The plurality of reservoirs may comprise at least one crushable ampule. The at least one crushable ampule may contain a solvent, a reagent, a buffer fluid or a combination thereof, for example. One example of a solvent is methanol. Another reservoir may contain a reagent, releasably, that is selected for colorimetric testing of a target chemical compound or element. A ring of dry reagent may be adhered on a surface of the nib. The surface may be distal from the tip or may be disposed at the tip. A first raised ring may divide the portion of the nib where the tip is located from the ring of dry reagent, for example. A second raised ring may divide the ring of dry reagent from the barrel or other rings of dry reagent. The ring or rings of dry reagent comprise a plurality of reagents. The plurality of dry reagents may be mixed together, in one example. Alternatively or in addition, a plurality of dry reagents may be disposed separately from each other along the surface either radially, longitudinally or a combination thereof.

In one example, a method of using such a device may comprise sampling a surface to be tested with the tip of the nib, releasing an evaporative fluid from the reservoir, such that the nib is wetted and saturated by the fluid, such as by crushing an ampule and/or squeezing the barrel to direct fluid from the reservoir to the tip of the nib, holding the nib downwardly, such that the fluid settles under gravitational acceleration to the tip of the nib, and concentrating any analyte that is carried by the portion of the fluid that settles at the tip of the nib during the step of holding by evaporating at least a portion of the fluid that settles at the tip of the nib. Then, some of the concentrated analyte and fluid may be transferred from the tip of the nib to a surface of a substrate. For example, the step of sampling may comprise holding the device such that a side of the nib distal from the tip of the nib makes direct contact with the surface to be tested. This may be combined with contacting the tip of the nib with the surface, also, which may be done by rotating the device at various angles with the surface to be tested. This may be done before the step of holding the nib downwardly, such that a larger surface of the nib is used for collection of trace amounts of analyte from a surface. If the fluid is a solvent for the analyte, then the analyte will be dissolved in the solvent and carried to the tip by gravity and/or evaporative transport from the tip, due to the higher curvature of the tip. In one method, a reagent is adhered to the nib, and the nib is evaluated colorimetrically to determine how any analyte in the fluid reacts with the reagent on the nib. In one example, the tip is used for transferring concentrated analyte to a TLC plate and/or a SERS substrate, and the ring is disposed on a side of the nib distal from the tip.

In one example, a case or housing is provided to protect the device when not in use. For example, a device may be inserted into a protective case with one or more caps closing one or more open ends of a tubular protective shell.

### BRIEF DESCRIPTION OF THE DRAWINGS

The following drawings are illustrative examples and do not further limit any claims that may eventually issue.

FIG. 1 illustrates a schematic illustration of a device.

FIG. 2 illustrates a detailed view of a tip of a device swabbing a solid sample.

FIG. 3 illustrates a detailed view of the tip spotting a plate, disk or slide.

FIG. 4 illustrates an example of a conical, truncated nib with a rounded end.

FIG. 5 illustrates a partially exploded and partially cross sectional view of a protective housing.

When the same reference characters are used, these labels refer to similar parts in the examples illustrated in the drawings.

### DETAILED DESCRIPTION

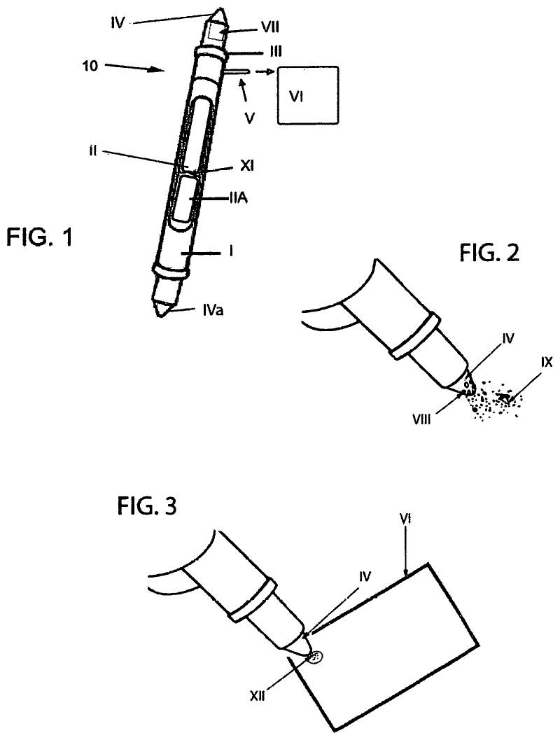

FIG. 1 shows a spotter tube made of a plastic such as polypropylene. A breakable glass ampule II is filled with a solvent, such as methanol. The nib IV has a tip that is cone-shaped or parabolically-shaped and is attached to the tube I by collar or holder III, which may be removable from the tube. Thus, a plurality of nibs IV may be provided for attaching to a tube. An optional suction outlet V may be capped or plugged when not in use. When used, it may be attached to a suction device VI for drawing an air sample through the nib IV. For example, a thermoelectric chiller VII may be activated to cool down a sintered metal nib as a “cold finger” for collecting condensate vapors from air. Then, the nib may be used to spot or otherwise text the condensate, such as by removing the nib and placing the nib in a spectroscope or the like.

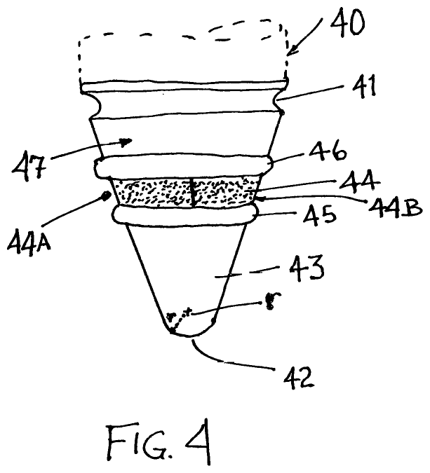

FIG. 2 shows a detailed view of the nib IV sampling a solid powdery substance IX, as an example of sampling any surface, solid or liquid. The ampule may be crushed, releasing the solvent before or after sampling the surface, and the nib may have an adhesive applied in spots VIII on its surface for assisting in the collection of powders. The nib IV may be used for transferring a sample, diluted by the solvent from the ampule II, onto a slide or plate, such as for TLC or other testing of the resulting spot of solvent, as illustrated by the dot XII in FIG. 3, for example. A second ampule IIA may contain a reactant or other fluid for conducting a second test, such as a colorimetric test, using the same nib IV. By breaking the ampule IIA, the reactant migrates to the tip through the hole XI separating the two ampules, and a color change, or change from light to dark or dark to light, can take place at the nib IV.

The same sample collection and transfer device 10 may be used for a plurality of tests such as TLC, colorimetric, spectroscopy and NMR, for example. In one example, the tip is a parabolic tip. Alternatively the tip is a truncated cone, having the tip of the cone rounded off at a radius of curvature suitable for a variety of sampling and testing protocols. For example, a tip may be selected having a radius of curvature of the tip that leaves a spot on surface, such as a TLC plate and a SERS disk, of about 0.5 to 2 mm in radius. Preferably a spot of about 1 to 1.5 mm is deposited on a flat surface by the tip. For example, the end of the tip of the nib may be selected to have a radius of curvature of about the same as the spot to be deposited on a flat plate. A universal sampling and spotting device may be provided that satisfies the requirements for a TLC testing device, spectroscopy testing device and a DNA testing device, such that the same or a similar sampling and spotting device is used for each of these different testing devices. In one example, one or more solvents or buffer solutions may be selected by releasing the solvent or buffer solution desired from one of a plurality of reservoirs in the sampling and spotting device and directing the solvent or buffer solution to the porous nib. The porous nib of the sampling and spotting device may be used to sample a surface before and/or after releasing a solvent or buffer. In one example, a second reservoir is activated, such as by crushing, to release a second fluid. The second fluid may be selected such that a chemical reaction occurs, such as a reaction that causes a change in color or shade of the nib, if a target compound is sampled by the nib. Alternatively, or in addition to colorimetric testing, the nib may be used to spot a TLC plate by directly contacting the tip of the nib onto a TLC plate, and/or the nib may be used to transfer a concentrated sample from the tip of the nib onto a SERS disk, and/or the nib may be used in FTIR and/or DNA sampling. For example, the nib may be removable and may be heated within in a thermogravimetric-infrared spectrometer analysis (TG-IR). The nib may be used to concentrate any sampled DNA on the tip of the nib using a buffer solution to wet the surface of the nib, while holding the nib pointing downward in relation to gravity. Therefore, any DNA picked up on the sides of the nib is directed downward toward the tip by the buffer solution.

For example the tip is made of a polymer, ceramic or metal. A porous polyethylene tip may be used for sampling and transfer in TLC, FTIR, SERS and DNA testing and may be used for colorimetric testing, also. A porous alumina, boron nitride, boride or carbide tip may be used for some or all of the same tests and may be better suited for some solvents and some target compounds that are not compatible with polyethylene, for example. A porous sintered metal or mixed metal/polymer, metal/glass or metal/ceramic tip may be preferred for use in some Raman spectroscopy testing, particularly if the tip is to be heated during testing.

In one example, a sampling and spotting device comprises a porous nib have a tip, and the nib is connected to a plurality of reservoirs disposed in a barrel or tube. The plurality of reservoirs may contain a plurality of solvents and/or reagents and/or buffer solutions, depending on what the sampling and spotting device is intended to be used for. For example, a device for sampling DNA may contain a buffer solution and additional reservoirs. In one example, DNA may be sampled first, and subsequently, additional sampling and transferring may be completed using the same tip. For example, a saline buffer or an ethylenediaminetetraacetic acid (EDTA) buffer may be used to collect and transfer DNA for testing or polymerase chain reaction (PCR) or DNA testing on a chip applications. Then, tests for other compounds may be completed using the same nib or a replaceable nib. For example, a test may use a methanol solvent for SERS testing. A crushable ampule of methanol may be crushed and the methanol may be directed to the nib to flush out any residual buffer solution. Then, traces of liquids, solids or powders may be concentrated onto the tip of the nib, as the methanol transports any traces from the nib to the tip. The methanol evaporates comparatively rapidly, leaving a dry residue on the tip, for example. Alternatively, the tip may be used to spot a SERS disk, after only a portion of the methanol evaporates, transferring a concentrated sample onto the testing region of SERS disk, which may be dried prior to spectroscopic testing of the sample. In this way, very low concentrations of a sampled target compound may be detected by first concentrating the sample on the tip of a nib having a shape that causes a solvent, such as methanol, to flush the surface of the nib and to transfer the solvent and solute to the tip of the nib. In one example, the nib is used for spotting a TLC plate for TLC analysis, either before or after spotting a SERS disk for SERS analysis. Therefore, two or more different tests may be conducted on a common, concentrated sample from the tip of a single nib, for example, without affecting the outcome from any of the tests. For example, after the transfer of samples to a plurality of other types of tests, a reagent is introduced at the tip of the nib, such as by breaking an ampule in the barrel of the device, and the tip is observed to determine if the reagent reacts with residue located at the tip. In this way, a colorimetric test may be performed prior to taking the time to complete any of the other tests, although plates, slides or disks for the other tests are already prepared, if a need for further analysis of the sample is indicated by testing with the reagent.

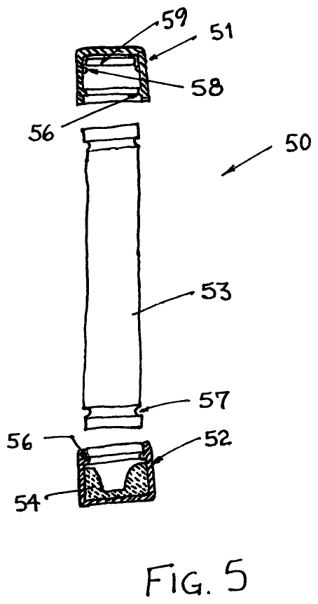

In one example, a ring of dry reagent 44 is disposed around a portion of the nib, as illustrated in FIG. 4, for example. The ring of dry reagent 44, when exposed to a sample suspended in a fluid or dissolved in a solvent, reacts with only certain chemical compounds in a way that indicates the presence of those certain chemical compounds, as is known in the art and disclosed by applicant and others in other patent applications, such as U.S. application Ser. No. 14/821,108, for example, which is incorporated by reference herein in its entirety. Herein, colorimetric testing is defined, broadly, to apply to any change in color, shade, intensity, luminosity or the like, whether reflected or emitted in wavelengths visible to the naked eye, or reflected or emitted in wavelengths not visible to the naked eye. The tip radius (r) may be selected as any radius for a truncated cone or parabolically shaped tip, for example. Preferably, in one example where the tip is to be used to transfer samples to TLC and SERS test substrates, the tip has a radius of curvature selected such that the resulting spot left by the tip has a radius of 0.5 mm to 1.5 mm, more preferably about 1 mm. In one example, a larger spot of about 2 mm is preferred for use in a plurality of tests including Raman spectroscopy tests requiring a larger spot than 1.5 mm. A conical portion of the tip 43 may be defined by a first raised ring 45 that divides the lower tip 42, 43 from the rest of the nib 40. The ring of reagent 44 may be deposited anywhere on the nib 40, as the porosity of the nib can carry a target compound dissolved by a solvent, which may be released from a reservoir in the barrel of the device, to the reagent in the ring where it will react, if present at sufficient concentration to cause a positive colorimetric indicator. A first of a plurality of dry reagents may be disposed radially on first side of the surface 44A, and a second of the plurality of dry reagents may be disposed on a radially opposite side 44B of the surface from the first side 44A, for example. In another example, a first reagent may be adhered to a first surface 44, 44A, 44B and a second reagent may be adhered to a ring around a second surface 47, longitudinally disposed from the first surface. In another example, a plurality of reagents for a universal sampling and transfer device may be disposed both longitudinally and radially one from the other or may be mixed together in any of various combinations and permutations.

A single ring 44 may provide a plurality of indications by applying different reagents at different locations or by mixing reagents together that each have a different color or the like, such that the resulting indication is determined by the net reaction(s) of more than one reagent. For example, a first reagent that undergoes a color change from light gray to blue may be combined with a second reagent that undergoes a color change from pale yellow to red. No change in color would indicate no reaction, a change to blue would indicate a reaction with the first reagent and no reaction with the second reagent, a change to red would indicate no reaction with the first reagent and a reaction with the second reagent, or a change to purple would indicated reactions with both the first reagent and the second reagent. By combining and separating different reagents in different locations, such as radially or longitudinally along the nib 40, a wide variety of colorimetric tests may be performed by a single, universal sampling and transfer device, for example.

In the Example in FIG. 4, the dots indicate one or more solid reagents 44 deposited and adhered onto the surface of the nib 40, like pixels on a television screen. A second raised ring 46 may be provided above the ring of reagent 44, for example. These raised rings 45, 46 may be used to sample a surface using the side of the nib 40 to contact a surface to be sampled. For example, one of a plurality of crushable ampules in the barrel of a device that is coupled fluidically with the nib 40 may be crushed to release a solvent. The solvent flows to and through the porous nib, for example. If the barrel is flexible, squeezing the barrel may force even more solvent to the nib, such that solvent pools on one or both of the rings 45, 46, as the nib 40 is held above a surface to be sampled. For example, the nib 40 may be held at an angle such that the rings 45, 46 are nearest to the surface and make contact with the surface, first. The nib 40 may be translated, rotated or rolled over the surface, such that the entire surface of the rings 45, 46, 360 degrees around the nib 40 are placed into contact with the surface to be sampled. Then, the universal sampling and transfer device may be raised vertically to the surface, and, optionally, the tip 42 may be used to sample the surface, also. The tip 42 may be used to transfer some of the solvent and anything dissolved or suspended in the solvent to one or more testing substrates, such as a TLC plate or SERS disk, for example. The ring 44 may be observed for a colorimetric test, based on a colorimetric change of the ring 44. Then, another fluid may be released, for example, by crushing a second ampule in the barrel of the device fluidically coupled to the nib 40. This fluid may be carried to the ring 44 and/or the tip 42 and may include another reagent, which can be used for additional testing or to confirm that the reagents in the ring 44 are still active (avoiding a false negative due to inactivation or loss of the reagents on the ring 44, for example). In this way, a single universal sampling and transfer device may be used for a variety of tests, may be used to screen for a plurality of target compounds and also provides a transfer device for concentration of solute at the tip 42 of the device for spotting substrates, such as for follow-on TLC and/or SERS testing, and the like. In one example, at least one crushable ampule of methanol is provided in the barrel of the device.

A tip curvature is defined herein, wherein the tip curvature is greater than the curvature of the surface of the nib at a distance (or distal) from the tip. At a distance means any distance and, in one example, the curvature of the nib substantially decreases with distance from the tip of the nib (at least until any curvature that is caused by the connecting region for connection with the barrel, for example). Of course, in the example in FIG. 4, the rings affect curvature, but in this case, the “nib” portion may be considered the lower portion, below the rings, only, for example. Regardless, the change in curvature allows the sampling surface to be greater than the tip surface. Thus, if the tip of the nib is held downwardly, solvent from the sampling surface will drain toward the tip, increasing the concentration of solute at the tip, if the solvent is evaporative, such as a methanol, ethanol, acetone or other solvent with a comparatively high vapor pressure, when compared to water. Of course, even water will evaporate over time, if given sufficient time or the temperature is raised or the tip is exposed to a stream of dry air. For example, a curvature of a spherically-shaped tip is defined as the inverse of the spherical radius of the tip. As known in the art, the curvature of any shape may be determined mathematically and decreases to zero for a flat plane and infinity for a hypothetically perfectly sharp tip or the edge of a sheet having no width.

Thus, a porous nib is defined herein as a sampling and transfer end effector that has fluidically interconnected channels through the solid phase of the end effector and a tip curvature greater than the curvature of the end effector distal from the tip. Also, the porous nib has a connecting region for connecting to the barrel of the device opposite from the tip porously connected fluidically to the tip, which may have grooves or ridges, as necessary to make an interference connection. The nib may be adhesively bonded to the barrel or may be joined, fused or mechanically fastened, for example.

The porosity of the nib may be selected for the fluids to be transferred through the nib. For example, Porex has porous polyethylene with fluidically interconnected pores with pore sizes from pore sizes ranging from 7 to 150 micrometers (equivalent diameters), and these nominal values may be increased up to 300 micrometers with special blends. Porex provides nibs for a variety of applications. A porous nib may have an average pore size of between about 50 μm and 80 μm, for example, with a porosity of between about 30 to 85 percent, preferably between about 60 and 75 percent, in some applications where easy flow through the nib and durability of the nib are critical. For example, the nib may be made of a sintered polyethylene, such as a high molecular weight polyethylene or ultra high molecular weight polyethylene for excellent chemical resistance.

For example, the device may be used as a spotter in thin layer chromatography. A chamber containing a fluid may be coupled to the tubular member coupled to the tip, for example, and the fluid, such as a diluent and/or solvent, may be directed to the tip through the porous network formed by partially sintering powdered materials. For example, the device may be a nib having a parabolic proximal end and a distal end shaped to be held in the tubular member fluidically coupling the chamber containing the fluid to the nib. In one example, the fluid is contained in one or more vials, such as glass vials that can be crushed to release the fluid, when needed. A second vial may contain a second fluid, which can be used for colorimetric testing, causing a chemical color change of the tip, indicating presence or absence of a chemical element or compound, for example.

The proximal end of the tip may be sized to “spot” the correct size of spot on a thin layer chromatography slide, for example. A spotting window on a thin layer chromatography kit may be provided for introducing the tip into a housing, such that the spot is positioned precisely where the spot is needed on the slide, for example. In this way, human error is reduced and thin layer chromatography may be completed in the field, for example.

In one example, the device comprises a tip for spotting a thin layer chromatography slide through a window in a housing and a colorimetric test kit. For example, the chamber comprises a first fluid releasable from a first vial, which is a suitable solvent for spotting whatever chemicals come into contact with the proximal end of the tip on a thin layer chromatography slide, and a second fluid releasable form a second vial, which is chemically reactive with one or more chemicals, such that a color change occurs at the tip.

Alternatively or in addition to colorimetric testing and thin layer chromatography testing, the tip may be made of a material that can be cooled below ambient, such that condensible vapor in gases drawn through the porous tip are condensed within the tip. For example, a suction device, such as a vacuum fan, may be fluidically coupled at an opposite end of tubular member from the tip. When the suction device is active, air surrounding the tip may be sucked through the tip by the suction device. The tip may be precooled by an external or internal chiller, such as a thermoelectric chiller, or the tip may be exposed to a cold fluid. The tip becomes a “cold finger,” and any vapors that are condensible at a temperature of the tip, which is less than the ambient temperature of the air, condense within or on the tip. The condensate may be spotted on a detector, such as a thin layer chromatography detector or spectrometer, for analysis of the condensate. In one example, a vial in the chamber may be crushed to release a reactant that causes a color or contrast change, and the tip becomes a spotter and/or a colorimetric test kit for the condensate. In one example, the spotter is used to spot a paper slide before and after release of one or more reactants, and color changes in the spots are compared to screen for the presence or absence of a particular substance or group of substances. In one example, before release of one or more reactants, the spotter is used to spot the surface of a thin layer chromatography slide. In one example, the tip is a removable nib, and the nib is removed and is inserted into a spectrometer. For example, the spectrometer may draw vapor from the nib, such as by heating, and the vapor may be examined spectroscopically for volatile chemical traces.

Thus, the device may be used as a sample collection and spotting device for a plurality of tests, such as thin layer chromatography, colorimetric testing and spectroscopy. For example, spectroscopy testing of a nib may include ion mobility spectrometry (IMS), gas chromatography mass spectrometry (GC-MS) or differential mobility spectrometry (DMS).

In one example, a sintered nib and/or the entire device is pickable by an automated pipetter that uses the nib for transferring a sample solution from one place to one or more other places, automatically or semi-automatically.

In one example, thin layer chromatography (TLC) is contemplated. The device is a spotter for a TLC plate or slide. For example, a first vial may contain a liquid solvent, such as methanol. In addition to methanol, the vial may contain a second compound, which may be used as a reference compound. In this way, the device may be used to spot a reference standard. Then, the tip may be used to interrogate a surface (such as by swabbing the surface or contacting the tip with a solid or liquid to be tested, such as a powder residue. Then, the device is used to spot the sample tested on the same or different TLC slide. In one example, a single slide has a plurality of tracks, separated one from another, but adjacent one to the other, such that the reference standard and the test track may be readily compared. In one example, the relative location of the TLC result is used to interpret the results in the field. In an alternative or the same example, a quantitative result may be determined by calibrating the results using the reference standard and determining a quantitative or semi-quantitative result from the results of TLC from the test spot.

For example, the device may replace a micropipette for TLC spotting. In one example, the nib has a shape other than a simple dot, such as a linear or rectangular shape. The more linear shape may provide an instant check to determine presence of a reactant on the tip, by darkening or a color change, for example. If only a portion of the linear tip is changed, then the tip may be moved to put the entire tip into contact with the substance to be tested, for example. The linear tip may be used for spotting, such as in TLC, and the precision of the TLC may be increased by better defining the distance from the linear “spot” and the end result on the TLC slide.

In one example, such as illustrated in FIG. 1, a plurality of nibs IV, IVa may be provided in a single device, such as by attaching a first nib IV on one end of the barrel and a second nib IVa on an opposite end of the barrel. For example, a first nib IV may be fluidically coupled to a first mobile phase II and the second nib IVa may be fluidically coupled to a second mobile phase IIA, merely by closing the hole XI connecting the two reservoirs. A difference in the result obtained may be used to indicate the type of substance tested or may increase reliability of the test. Alternatively, one nib IV may be made of a different material than another nib IVa. For example, one may be a comparatively highly conductive sintered metal IV and the other may be a polymer IVa, such as sintered polyethylene. A device may comprise a plurality of nibs, of the same type or different types, and a plurality of vials, containing a plurality of different solvents and/or reactants that may be used for rapid substance screening and detection in the field, for example.

In one example, a single device is used for both Raman spectroscopy and Fourier transform infrared spectroscopy by making the nib removable from the tubular member to which it is coupled during sample collection. For example, the nib may be held by a collar that is detachable from the tubular member. In one example, the nib is removable and may be replaced onto another tubular member, which contains a different solvent, such as chloroform, which allows the same nib to be used for FTIR, after having been used for Raman spectroscopy, previously. For example, a sintered metal nib may be used in a surface enhanced Raman spectroscopy (SERS) using a metal such as Au, Ag, Cu, Li, Na, K, Pd or Pt metal or alloy, which may be added into a polymer, for example. In another example, the nib may comprise nanotubes, such as carbon nanotubes, which may be functionalized to absorb one or a plurality of chemical substances, for example.

In one example, an array of colorimetric reaction sites, such as using one or more dry reagents deposited onto a piece of paper, such as filter paper, may be disposed at different locations or branches from a single fluidic channel. The nib of the spotter may be used to deposit a sample at one end of a fluidic channel fed by an ampule or vial. Alternatively, the solution may be squeezed from the device and may disposed at the beginning of a microfluidics channel that may be patterned on the paper using a printer, such as a wax printer. In this example, the solvent is a carrier of the solute to a plurality of spots for testing using a plurality of reagents or reactants at each of the spots, which may be at the end of a branch from a trunk. If an analyte is present in the sample, a colorimetric change may occur.

In FIG. 5, an example of a protective housing shows an outer, tubular shell 53 having one or more open ends, and one or more caps 51, 52 capable of engaging the shell 53. For example, a protruding ring 56 may be provided on a cap that engages a groove 57 in the outer wall of the shell 53. In a first cap 52, a foam material 54 is shown. The foam material 54 may be shaped to protect a nib of a device, when the device is stored in the housing 50. Alternatively or in addition to a foam material 54, a second cap 51 shows a SERS disk 59 stored in an inner, top portion of the cap 51, for example. Protrusions 58 may be provided to retain the disk 59 in the cap 51, or the disk may be retained by an adhesive or the like.

This detailed description provides examples including features and elements of the claims for the purpose of enabling a person having ordinary skill in the art to make and use the inventions recited in the claims. However, these examples are not intended to limit the scope of the claims, directly. Instead, the examples provide features and elements of the claims that, having been disclosed in these descriptions, claims and drawings, may be altered and combined in ways that are known in the art.

1. A universal sampling and transfer device comprises:
a barrel comprised of an external housing and at least one reservoir; and
a nib, fluidically coupled to the barrel and the at least one reservoir, wherein the nib has a tip with a tip curvature greater than the curvature of the nib distal from the tip, wherein the reservoir releasably contains an evaporative fluid, and the evaporative fluid wets the nib, when the nib is held downwardly, such that the evaporative fluid settles under gravitational acceleration to the tip of the nib, concentrating any analyte that is carried by the portion of the evaporative fluid that settles at the tip of the nib, such that fluid transferred from the tip of the nib contains concentrated analyte.

2. The device of claim 1, wherein the nib is made of a sintered polyethylene.

3. The device of claim 2, wherein the porosity of the nib is selected in a range from 60 to 75 percent.

4. The device of claim 1, wherein the at least one reservoir comprises a plurality of reservoirs.

5. The device of claim 4, wherein the plurality of reservoirs comprise at least one crushable ampule.

6. The device of claim 5, wherein the at least one crushable ampule contains a solvent.

7. The device of claim 6, wherein the solvent is methanol.

8. The device of claim 7, wherein another reservoir comprises a reagent selected for colorimetric testing of a target chemical compound or element.

9. The device of claim 1, further comprising a ring of dry reagent adhered on a surface of the nib.

10. The device of claim 9, wherein the surface is distal from the tip.

11. The device of claim 10, wherein a first raised ring divides the tip of the nib from the ring of dry reagent.

12. The device of claim 11, wherein a second raised ring divides the ring of dry reagent from the barrel.

13. The device of claim 9, wherein the ring of dry reagent comprises a plurality of reagents.

14. The device of claim 13, wherein the plurality of dry reagents are mixed together.

15. The device of claim 13, wherein the plurality of dry reagents are disposed separately from each other on the surface.

16. The device of claim 15 wherein a first of the plurality of dry reagents is disposed radially on first side of the surface, and a second of the plurality of dry reagents is disposed on a radially opposite side of the surface from the first side.

17. The device of claim 15 wherein a first of the plurality of dry reagents is disposed longitudinally along the surface of the nib separated by a longitudinal distance from a second of the plurality of dry reagents.

18. A method of using the device of claim 1, comprising:
sampling a surface to be tested with the tip of the nib;
releasing an evaporative fluid from the reservoir, such that the nib is wetted and saturated by the fluid;
holding the nib downwardly, such that the fluid settles under gravitational acceleration to the tip of the nib;
concentrating any analyte that is carried by the portion of the fluid that settles at the tip of the nib during the step of holding by evaporating at least a portion of the fluid that settles at the tip of the nib; and
transferring some of the fluid from the tip of the nib to a surface of a substrate after the step of concentrating.

19. The method of claim 18, wherein the step of sampling comprises holding the device such that a side of the nib distal from the tip of the nib makes direct contact with the surface to be tested before the step of holding the nib downwardly.

20. The method of claim 19, wherein a reagent is adhered to the nib, and further comprising a step of colorimetrically evaluating how the analyte reacts with the reagent.
